(19) United States
(12) Patent Application Publication
(10) Pub. No.: US 2015/0186958 A1
(43) Pub. Date: Jul. 2, 2015

(54) SYSTEM AND METHOD FOR RATING POINTS OF INTEREST BASED ON A LOCATION HISTORY

(71) Applicant: Dean Kenneth JACKSON, Pittsburgh, PA (US)

(72) Inventor: Dean Kenneth JACKSON, Pittsburgh, PA (US)

(73) Assignee: GOOGLE INC., Mountain View, CA (US)

(21) Appl. No.: 13/431,856

(22) Filed: Mar. 27, 2012

(51) Int. Cl. G06Q 30/02

(52) U.S. Cl. CPC G06Q 30/0282; H04W 4/028

(57) ABSTRACT

Systems, methods, and machine-readable media for rating points of interest (POIs) using a mobile device location history are provided. Multiple location information may be received from a mobile device. For some location information of the multiple location information, POIs associated with the location information may be identified. A location history based on the identified POIs may be generated. The location history may comprise a POI list including one or more POIs visited by a user of the mobile device. A rating interface may be generated based on the location history to enable rating of one or more POIs of the POI list subsequent to a time associated with a received location coordinate for which the at least one POI was identified. The system, in one aspect, may include a communication module, an identification module, a location history module, an interface module, memory, and a display device.

### BACKGROUND

Several systems may allow users to rate points of interest (POIs). Some systems may allow users to search for the points of interest based on the user's current location. However, in order for a user to rate a point of interest that the user is visiting, the user may have to take the time and effort to pull out a mobile device, search for the POI, and rate the POI. Frequently the user is no longer at the POI when she has the time to input a rating. The user may need to search through numerous possibilities in order to recall the POI that the user has visited in the past. The POI may be a branch of a chain with many similarly or identically named stores near the location that the user has been at. In that case (and others), it may be difficult for the user to identify the particular point of interest, at which the user has been some time ago.

### SUMMARY

According to one aspect of the subject technology, a system for rating points of interest (POIs) using a mobile device location history is provided. The system may include a communication module, memory, an identification module, a location history module, and an interface module. The communication module may be configured to receive location information for a plurality of locations at which the mobile device was present from a mobile device associated with a user. The memory may store a database of location information based on the plurality of location information received from the one or more mobile devices. The identification module may be configured to identify, using the received location information, POIs associated with some of the locations. The location history module may be configured to generate a location history based on the identified POIs. The location history may comprise data objects identifying the identified POIs. The communication module may be configured to transmit to a device authorized by the user, one or more portions of the location history and instructions for causing the authorized device to display a graphical user interface and prompt the user to provide responses to POIs in the location history.

According to another aspect of the subject technology, a method for rating points of interest (POIs) using a mobile device location history is provided. According to the method, location information for a plurality of locations at which the mobile device was present may be received from a mobile device associated with a user. Using the received location information, for some location information of the multiple location information, POIs associated with the location information may be identified. A location history based on the identified POIs may be generated. The location history may comprise data objects identifying the identified POIs. At least a portion of the location history and instructions for causing the authorized device to display a graphical user interface and prompt the user to provide responses to POIs in the location history may be transmitted to a device authorized by the user of the mobile device.

According to yet another aspect of the subject technology, a non-transitory machine-readable medium including instructions stored therein, which when executed by a machine, cause the machine to perform operations for rating points of interest (POIs) using a mobile device location history is provided. The operations may include receiving location information for a plurality of locations at which the mobile device was present from a mobile device associated with a user. Using the received location information, for some location information of the multiple location information, POIs associated with the location information may be identified. The operations may also include generating a location history based on the identified POIs, the location history comprising data objects identifying the identified POIs. The operations may further include transmitting, by the server, to a device authorized by the user, one or more portions of the location history and instructions for causing the authorized device to display a graphical user interface and prompt the user to provide responses to POIs in the location history.

According to yet another aspect of the subject technology, a method for rating points of interest (POIs) using mobile device location history is provided. According to the method, a plurality of location information may be received. A user interface may be displayed. The user interface may include a rating interface that can enable rating of one or more POIs of a POI list. The rating interface may be generated based on a location history. The POI list may include one or more POIs visited by a user of the mobile device. For some location information of the plurality of location information, POIs associated with the location information may be identified. The location history may be generated based on the identified POIs and may comprise the POI list.

According to yet another aspect of the subject technology, a mobile device enabled for rating points of interest (POIs) using mobile device location history is provided. The mobile device may include a location manager, a processor, memory, and a display unit. The location manager may be configured to receive, from a location service on the device, location information for a plurality of locations at which the mobile device was present. The processor may be configured to identify, by querying a database or a remote service, POIs associated with at least some of the locations of the plurality of locations. The memory may store a location history based on the identified POIs, the location history may comprise data objects identifying the identified POIs. The display unit may be configured to display a graphical user interface that prompts the user to provide responses to POIs in the location history.

According to yet another aspect of the subject technology, a mobile device enabled for rating points of interest (POIs) using mobile device location history is provided. The mobile device may include a location manager, a receiver module, and a display unit. The mobile device may include a location manager configured to obtain positional location information for the device. The receiver module may be configured to communicate a number of location information. The display unit may be configured to display a user interface. The user interface may include a rating interface generated based on a location history and may enable rating of at least one POI of a POI list. The POI list may include one or more POIs visited by a user of the mobile device. For at least some location information of the plurality of location information, POIs associated with the location information are identified. The location history may be generated based on the identified POIs and may comprise the POI list.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1 is a conceptual diagram illustrating a network environment for rating points of interests (POIs), in accordance with one aspect of the subject technology.

FIG. 2 is a block diagram illustrating a system for rating POIs, in accordance with one aspect of the subject technology.

FIG. 3 is a diagram illustrating a flow for generating a location history of POIs, in accordance with one aspect of the subject technology.

FIG. 4 illustrates an example of a user interface displaying a map and a chart showing POIs for receiving user input, in accordance with one aspect of the subject technology.

FIG. 5 illustrates an example of a user interface for rating visited POIs, in accordance with one aspect of the subject technology.

FIG. 6 is a flow diagram illustrating a method for rating a POI based on a location history, in accordance with one aspect of the subject technology.

FIG. 7 is a flow diagram illustrating a method for rating a POI based on a location history, in accordance with one aspect of the subject technology.

### DETAILED DESCRIPTION

Disclosed herein are systems and methods for rating points of interest (POIs) based on prior locations of a user. Information about prior locations can be stored in the form of a location history, e.g., comprising a data structure that comprises a plurality of coordinates sets or a plurality of location identifiers. The location history may be generated based on location information, e.g., location coordinates such as latitude and longitude, identified by a mobile device associated with the user. The user of the mobile device can be prompted for a user response to the location, e.g., on the mobile device or on another device, such as a desktop computer or another mobile device. In one aspect, the user response is solicited using a rating user interface that may be generated to enable the user of the mobile device to rate the visited POIs.

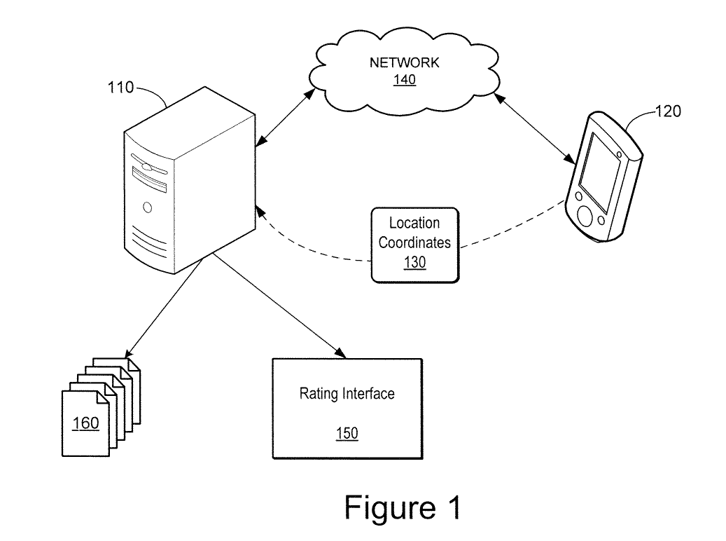

FIG. 1 is a conceptual diagram illustrating an environment for rating points of interests (POIs), in accordance with one aspect of the subject technology. The server 110 may receive location information 130 of a user of a mobile device 120 (e.g., a smart phone, a mobile computer, a tablet computer, a personal digital assistant (PDA), a global positioning system (GPS) device, etc.), via a network 140 (e.g., the Internet) from mobile device 120. The user may wish to rate various visited POIs, such as business places (e.g., restaurants, coffee shops, gyms, theatres, concert halls, art centers, etc.), public places (e.g., national parks, beaches, zoos, city parks, shopping centers, etc.), tourist attractions (e.g., museums, castles, churches, towers, markets, other historic places, etc.), and events (e.g., concerts, ball games, circuses, etc.).

The user may wish to rate one or more of the visited POIs, in a later time, for example, after returning from a trip or after returning to a hotel or residence following a day of excursion and touring several POIs, or may wish to provide the response on a different device from the mobile device. The user interface can aid the user in recalling visited POIs, e.g., a set of POIs where the user has spent at least a threshold amount of time within a certain time interval, e.g., POIs which the user has rated previously. Server 110 may receive a set of the location information from the one or more mobile devices 120. The location information may include location coordinates (e.g., a geographical latitude and longitude), GPS information, wireless fidelity (Wi-Fi), or other wireless transmitter source (e.g., cellular tower) information. The Wi-Fi source information may include a location coordinate, an identifier of the Wi-Fi source, and a signal strength associated with a signal received by the Wi-Fi source from the mobile device 120. Based on the received location information, server 110 may generate a location history 160 including a list of POIs identified based on the multiple location information (e.g., of location visited by the user of mobile device 120). Server 110 may also generate a rating interface 150 based on location history 160. The rating interface 150 may allow a user of mobile device 120 to rate one or more visited POIs or ranked by users of other mobile devices (e.g., other than used by the user of mobile device 120), in a later time and from a location far from the visited POIs

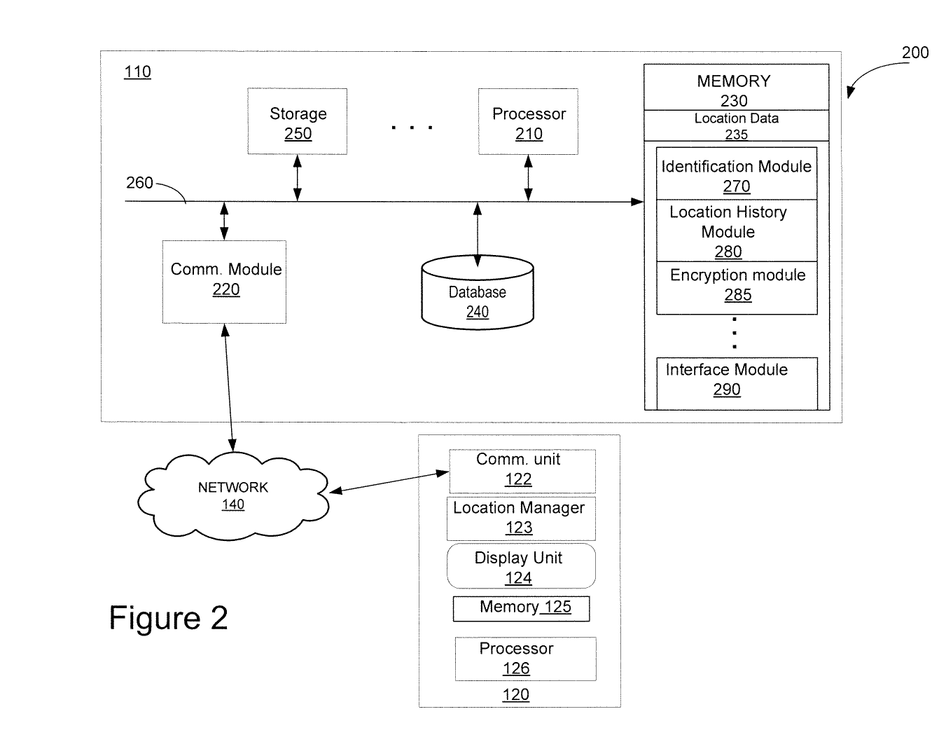

FIG. 2 is a block diagram illustrating a system 200 for rating POIs, in accordance with one aspect of the subject technology. System 200 may include server 110, network 140 and mobile device 120. Server 110 may comprise any system or device having a processor, a memory, and communications capability for receiving location information from a mobile device and may enable the user of mobile device 120 to rate a number of visited POIs. Server 110 may be a virtual entity that might refer to a cluster or even multiple clusters of servers. Server 110 may include a processor 210, communication module 220, a database 240, and a storage unit 250, coupled to each other and to memory 230 via a bus 260. Server 110 may include other known modules and units, such as an input/output interface that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Memory 230 may include random access memory (RAM), dynamic RAM (DRAM), static Ram (SRAM), flash memory, etc. Memory 230 may store various data including location data 235 and a number of software modules including an identification module 270, a location history module 280, an encryption module 285, and an interface module 290. In some aspects, identification module 270, location history module 280, and interface module 290 may be implemented in firmware or hardware. In some aspects, identification module 270, location history module 280, and interface module 290 may be stored on a storage 250, which may include one or more machine-readable media. Server 110 may communicate with mobile device 120, via network 140.

Network 140 may include, for example, any one or more of a personal area network (PAN), a local area network (LAN), a campus area network (CAN), a metropolitan area network (MAN), a wide area network (WAN), a broadband network (BBN), the Internet, and the like. Further, the network 140 can include, but is not limited to, any one or more of network topologies, including a bus network, a star network, a ring network, a mesh network, a star-bus network, tree or hierarchical network, and the like.

Mobile device 120 may include any client device capable of communicating with server 120, such as a smart phone, a mobile computer, a tablet computer, a personal digital assistant (PDA), and a global positioning system (GPS) device. Mobile device 120 includes a communication unit 122, a location manager 123, memory 125, a display unit 124, and a processor 126. Mobile device 120 may include other hardware, firmware, or software modules not shown in FIG. 2 for simplicity, such as memory, input/output device, applications, etc.

Referring to server 110, processor 210 may be a general-purpose processor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The machine-readable medium may be a single medium or multiple media (e.g., a centralized or distributed database, and/or associated caches and servers) that store the one or more sets of instructions. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Communication module 220 may be implemented in hardware or a combination of hardware, software and/or firmware. Communication module 220 may receive location information from mobile device 120, e.g., a number of location information from one or more mobile devices 120. The location information may represent the location information of the places at which mobile device 120 has been in the last predetermined period of time (e.g., last 3 minutes, or 3 weeks). The mobile device 120 may report its location in predetermined periods of time (e.g., every 3 minutes). In one aspect, communication module 220 may also receive each location coordinate with an associated time indicating a time that the mobile device 120 was located near that location coordinate and the user of the mobile device 120 was presumably in a near vicinity of that location coordinate. Communication module 220 may further receive each location coordinate with an associated time duration indicating a time duration that the mobile device 120 was not moving substantially from that location coordinate. This may indicate that the user of the mobile device 120 was presumably staying in a near vicinity of that location coordinate for that time duration. The location information and their associated times and time durations may be stored in a location data 235 of memory 230. Encryption module 285 may encrypt location information prior to storing the information in the location data 235.

Still referring to FIG. 2, database 240 may be a local server database stored in a memory of server 110, for example, in memory 230, or in storage 250. In some aspects, database 240 maybe external to server 110, for example, stored in a remote server or a client device or be distributed on a number of servers as a distributed database. Database 240 may store information relating to a number of POIs. The information may include identification information (e.g., a name, such as a museum name), geographic location information (e.g., country, state, city, etc.), location information boundary information (e.g., some location information that specify boundaries of the POI location), category (e.g., public place, business place, event place, tourist attraction, etc), and the like. Database 240 may be indexed by various indices such as identification information, geographic location information, category and the like.

Server 110 may receive location information from multiple mobile devices and store the received location information on database 240. Server 110 may provide the location information and rankings received from other mobile devices that relates to one or more POIs to a user of mobile device 120 and solicit rating of that POIs by the user of mobile device 120. The server may use processor 210 to process the rating results related to a POI received from multiple users, for example, to generate various aggregated or average ratings based on the rating results. Server 110 may communicate the average rating or an overall rating based on the aggregated values of the rating results to the user of the mobile device 120 or users of other mobile devices.

In an aspect, communication module 220 may receive location information from a plurality of mobile devices (e.g., mobile device 120). Each of the mobile devices may be associated with a user. Server 110 may store each location history in a secure format with information associating the location history with the corresponding user. Communication module 220 may receive location information for those locations at which the user has interacted with the mobile device to record the user's presence at the respective location. In an aspect, server 110 may limit the location history to POIs corresponding to such locations.

Identification module 270 may use the location data 235 and the POI information stored in database 240 to identify one or more POIs visited by the user of mobile device 120 (hereinafter “the user”). The identification module may include known search methods that for each location coordinate stored in the location data 235 query database 240 to search for an associated POI. If a POI is found for a location coordinate or a group of location coordinates, then it can be assured, based on an associated time durations stored for that location coordinate of the group of location coordinates that the POI was visited by the user. For example, identification module 270 may list a POI in the POI list of the location history 160 as a visited POI by the user, if the associated duration times satisfy a condition, for example, are longer than a predetermined period of time (e.g., 10 minutes), indicating that the user most likely spent at least 10 minutes in that POI. Identification module 270 may be able to obtain boundary location coordinate associated with a POI from database 240. Identification module 270 can then determine the associated time duration associated with the POI based on the associated times of location coordinates within that boundary.

In some embodiments, the location history can be generated in response to user triggers (e.g., user initiated check-ins). Server 110 may receive the check-in information associated with the POI from the website. Identification module may use the checking information as an evidence that the user visited the POI. This is particularly useful when a POI includes a number of sub-locations of interest, for example, when the user visits Eiffel Tower and spends some time in a specific coffee shop or gift shop in the Tower, it may not be easy to identify the location of the coffee shop or the gift shop from the location coordinates alone. The check-in information, for example, can help the identification module 270 to specifically identify the sub-locations of interest visited by the user or to gauge a threshold interest of the user in locations. In some embodiments, the user grants an authorization to the mobile device or an application running on the device to provide location information, e.g., from a location manager on the mobile device to the server.

In an aspect, the identification module 270 may determine a POI visited by the user of the mobile device by identifying a WiFi hotspot, known to be associated with the POI, in a WiFi connection records of the mobile device. A WiFi hotspot may be uniquely identified by, for example, a service set identifier (SSID) and a media access control (MAC) address. The identification module may query a database of SSID or MAC addresses to obtain SSID or MAC address of the WiFi hotspot. So, when the user of the mobile device is traveling in a location where GPS signal is weak, the position of the mobile device may be determined based on connection information recorded in the mobile device showing that user has connected to a hotspot, which can be identified based on a SSID or MAC address available form the database.

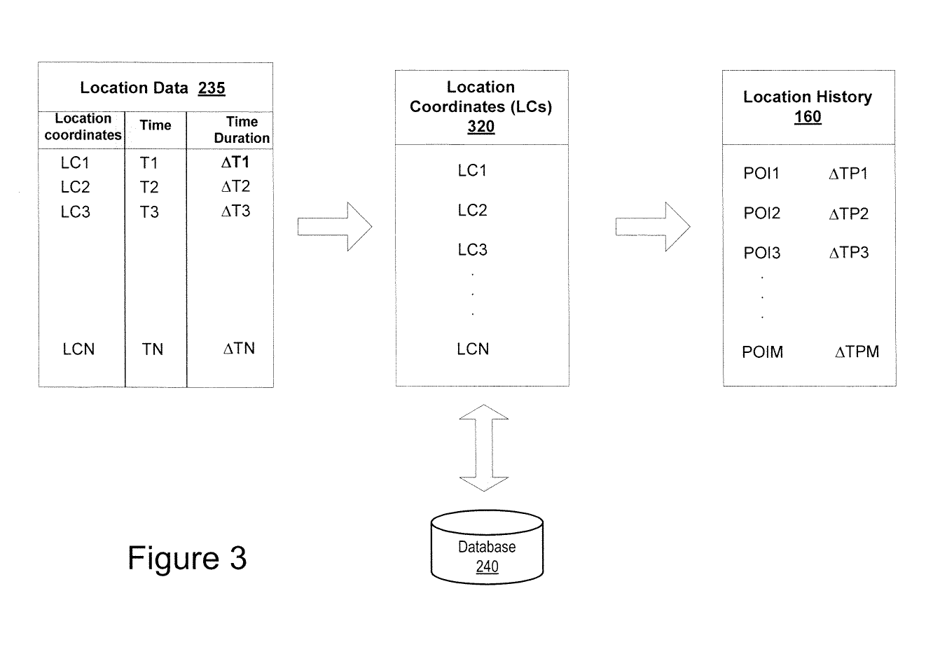

Location history module 280 may be configured to generate a location history based on the identified POIs. The location history may comprise data objects that identify the POIs that are identified by the identification module 270. Each data object may comprise a unique identifier (e.g., POI1, POI2 POIM, of FIG. 3) that references the POI in a POI database (e.g., database 240). Location history module 280 may comprise a POI list that includes a list of one or more POIs visited by the user. The information stored in a POI list may also include the time duration associated with each POI visited by the user and/or one or more times or time intervals when the user was at the POI. As mentioned above, some of the information relating to a visited POI may be obtained from check-in services. In cases where the user has visited a POI or one or more sub-location of the same POI (e.g., POI being the Eiffel Tower and the sub-location being a coffee shop in the Eiffel Tower) for a number of times, location history module 280 may include only the first visit to that POI or the sub-location of the same POI in location history 160. The location history may also comprise chronological information that indicates when mobile device 120 was present at the POIs. The chronological information may be received with the location information for at least some of the locations. The chronological information may also indicate the duration that the mobile device was present at the POIs.

Still discussing FIG. 2, the interface module 290 may be configured to generate a rating interface base on location history 160. The rating interface may include one or more user interfaces that allow the user to rate, in a later time, one of more POIs visited by the user from a location far from the location of the visited POIs. The user interfaces may include one or more maps or charts (e.g., tables) showing or listing the location of the POIs. The user interface, for each shown or listed POI, may also allow the user to confirm that the user has actually visited the POI and wish to rate that POI.

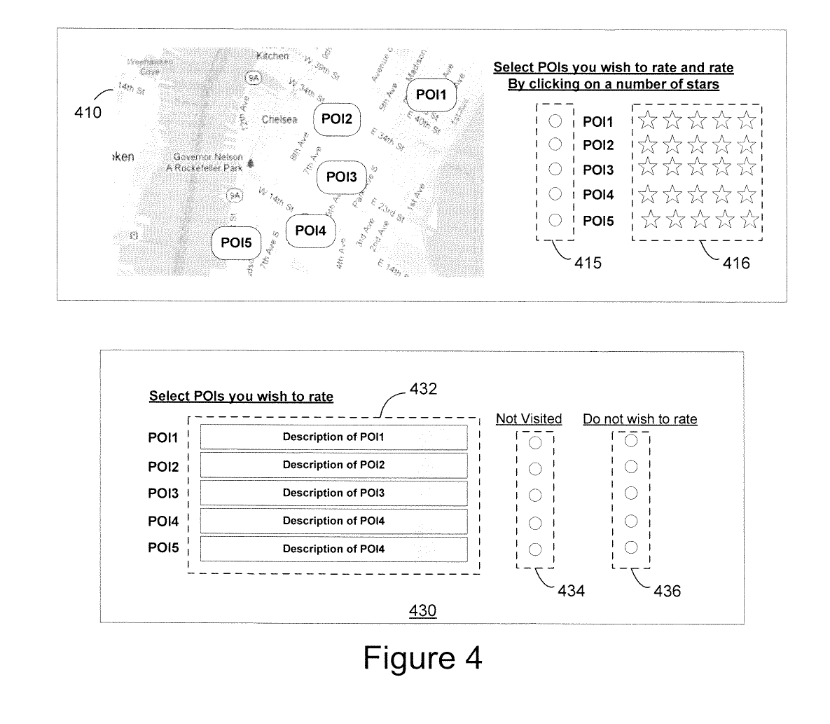

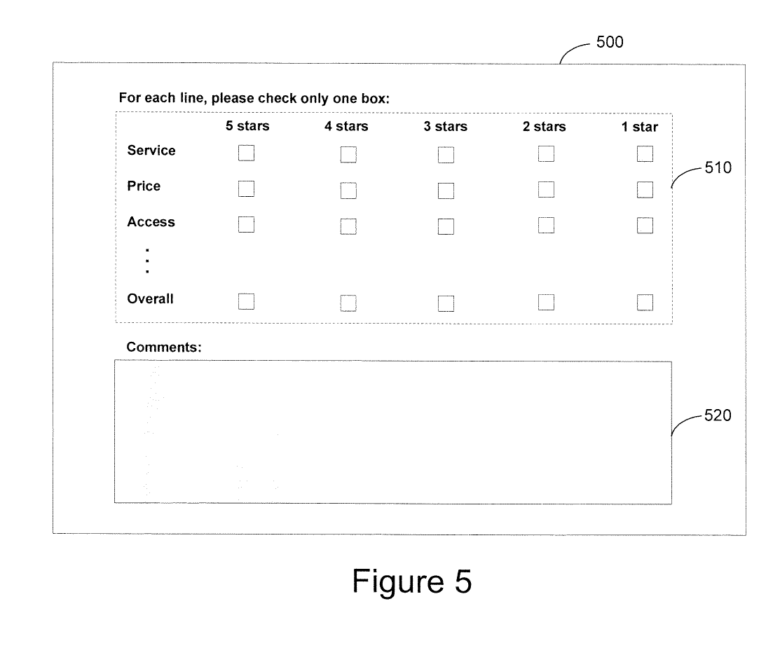

In some aspects, communication module 220 may prompt the user (e.g., transmit electronic messages (e.g., email, text message, etc.) to the user), after one or more POIs are identified as most likely visited by the user, to inquire whether the user is willing to provide a user response, such as a rating for those POIs. In some aspects, the user may initiate rating of the visited POIs by activating a user interface or navigating to a website associated with server 110. The website can provide a user interface (see examples in FIGS. 4 and 5) to rate the POI or POIs the user wishes to rate.

In an aspect, communication module 220 may transmit to mobile device 120 or a device authorized by the user of mobile device 120 (e.g., another mobile device or other device) portions of location history 160 and instructions for causing the mobile device 120 or the authorized device to display a graphical user interface and prompt the user to provide responses to POIs in location history 160. The portion of location history 160 transmitted to mobile device 120 my be limited the POIs for which server 110 does not have a response from the user or POIs for which the server does not have at least a threshold number of (e.g., three) responses from users.

Referring to mobile device 120 of FIG. 2, location manager 123 may be configured to obtain location information for the mobile device. Communication unit 122 may be configured to communicate with the communication module 220 and provide location information and associated time and associated time durations to server 110. Communication unit 122 may also be configured to receive signals from a location monitoring system such as a number of satellites (e.g., three satellites) of a global positioning systems (GPS). In one aspect, communication unit 122 may transmit the GPS signals to the communication module 220, for server 110 to process the GPS signals and obtain the location information including location coordinates, the associated times and the associated time durations. In another aspect, location manager 123 may obtain the location information, the associated times and the associated time durations from the received GPS signals. In yet another aspect, the location manager 123 may obtain the location information from signals received from a number of (e.g., at least three) cellular towers, for which the mobile device 120 may have position information.

In yet another aspect, location manager 123 may receive location information from a location service on the mobile device. Mobile device 120 may use processor 126 to identify POIs associated with at least some of the locations. Mobile device 120 may query a database (e.g., database 240) or a remote server (e.g., server 110) to provide information to processor 126 to identify the POIs. Mobile device 120 may also store in memory 125 a location history based on the identified POIs. The location history may comprise data objects that can identify the POIs. Each data object may comprise a unique identifier (e.g., POI1, POI2 . . . POIM, of FIG. 3) that references the POI in a POI database (e.g., database 240).

Mobile device 120 may use processor 126 to process the GPS signals or cellular tower signals and obtain location information. In some aspects, mobile device 120 may utilize firmware or software applications executable by processor 126 to process the GPS signals or cellular tower signals. For example, the firmware or software applications may use a well-known triangulation method to obtain the location information of mobile device 120. The location information of mobile device 120 may include location coordinates including a latitude, a longitude, and an altitude (xyz, for example in tall structures with multiple levels); or polar coordinates. For calculating an associated time duration for a location coordinate, mobile device may rely on location information sampled over time or an accelerometer data for example, the duration of time that the mobile device is not moving substantially or stays in a nears vicinity (e.g., within a zone with a predetermined radius such as 300 feet) of a location coordinate. In an aspect, the location manager 123 may provides information indicating that the location has not changed. Alternatively, mobile device 120 may analyze signals from location systems such as GPS to detect lack of movement characterized by a substantially slow down of the movement of the signals or no movement of the signal out of a certain boundary associated with the POI, indicating that the mobile device 120 has not moved out of that boundary. The mobile device 120 may store information such as the location information in memory 125.

Display unit 124 may be configured to display a user response interface, e.g., the rating interface to the user. Display unit 124 may include hardware, firmware and software executable by the processor 126 and a display (e.g., a liquid crystal display (LCD) or a touch sensitive display)) to display the user interfaces.

FIG. 3 is a diagram illustrating a flow for generating a location history of POIs, in accordance with one aspect of the subject technology. As discussed above, location data 235 stored in memory 230 of FIG. 2 may include, for location coordinates (LCs) (e.g., LC₁-LC_{N}), associated times (e.g., T₁-T_{N}), and associated time durations (e.g., ΔT₁-ΔT_{N}). Identification module 270 of FIG. 2 may store the location coordinates in a list 320 and compare the location coordinates of the list 320 with POI information stored in database 240 to identify some POIs associated with the location coordinates. The identified POIs may then be used by location history module 280 to generate location history 160 including a number (e.g., M) POIs (e.g., POI₁-POI_{M}) visited by the user. Location history 160 may also include associated duration times (e.g., ΔTP₁-ΔTP_{M}), each indicating the time that the user may have spent in a respective POI.

The time information may also be used to determine whether the user of the mobile device has participated in an scheduled or unscheduled event, for example, by checking an event database (e.g., a database of schedules of theatres, movies, concerts, meetings, lectures, rallies etc). If the user has participated in the event, then the server 110 of FIG. 2 may solicit user of the mobile device for rating of the event.

FIG. 4 illustrates an example of a user interface displaying a map 410 and a chart 430 depicting POIs for receiving user input, in accordance with one aspect of the subject technology. Depending on POIs listed in location history 160, the map 410 may be a regional map (e.g., a map of Europe, Asia, Middle East, etc), a country map (e.g., a map of United States, Canada, Germany, etc.) or a map of a state (e.g., California, New York, British Colombia, etc.) or a city map (e.g., a map of San Francisco, Chicago, Berkeley, etc.) or the like. Map 410 may show POIs using an icon, e.g., a place marker, or any of various icons including pictures, text, and /or numbers. On the side of the map 410, the user interface may show a list of the depicted POIs (e.g., POI₁-POI₅) and a check box block 415 including a check box for each depicted POI, so that the user can select the POI that the user is willing to rate. The user interface may also include a portion 416 where the user may directly rate one or more of the depicted POIs by clicking on a desired number of stars provided for that POI in portion 416.

Chart 430 may include the list of depicted POIs as well a description for each depicted POI shown in description block 432. Check box blocks 434 and 436, respectively, allow the use to indicate, based on the description, whether the user has actually visited the respective POI, and whether the user is willing to rate the respective POI. The descriptions may include any description of the depicted POI, including any combination of information relating to the depicted POI, for example, an identification (e.g., name of the location), address, phone number, name of a personnel (e.g., a manger), etc. The user interface may use other combinations of maps, descriptions, check boxes and other features to depict the POIs listed in location history 160. The user interfaces shown in FIG. 4 may be displayed on the mobile device 120 of FIG. 2 or a website associated with server 110 of FIG. 2.

FIG. 5 illustrates an example of a user interface for rating visited POIs, in accordance with one aspect of the subject technology. The user interface includes a ranking portion 510 and a comment portion 520. The selection portion may allow the user to rate POIs in a number of categories, qualities, or features such as, service, price, access, etc. The user may rank the visited POI, for example, from 1 star to 5 stars. Other methods of ranking may be used instead of ranking portion 510. In the comment portion, the user may add additional comments regarding any of the categories, qualities, and features as the user wishes. The ranking interface, however, is not limited to the shown user interfaces and may include other user interfaces with similar or different features. The user interface shown in FIG. 5 may be displayed on the mobile device 120 of FIG. 2 or a website associated with server 110 of FIG. 2.

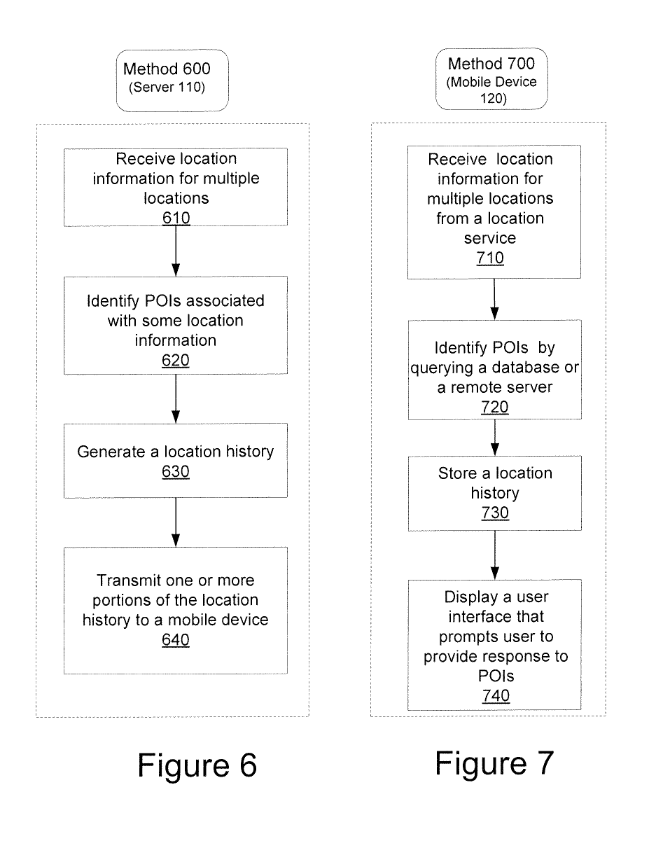

FIG. 6 is a flow diagram illustrating a method 600 for rating a POI based on a location history 160, in accordance with one aspect of the subject technology. Method 600 begins with operation 610, where the server 110 of FIG. 2, receives location information for a number of locations from a mobile device (e.g., mobile device 120 of FIG. 2) associated with a user. The identification module 270 of FIG. 2, then identifies, for some location information, POIs associated with the location coordinate (operation 620). At operation 630, location history module 280 of FIG. 2 may generate location history 160 of FIG. 1, based on the identified POI. Location history 160 may include data objects identifying the identified POIs. Communication module 220 of FIG. 2, at operation 640, may transmit to a device authorized by the user portions of the location history and instructions for causing the authorized device to display a graphical user interface and prompt the user to provide responses to POIs in the location history.

FIG. 7 is a flow diagram illustrating a method 700 for rating a POI based on a location history 160, in accordance with one aspect of the subject technology. Method 700 begins with operation 710, where location manager 123 of FIG. 2 receives location information for a number of locations at which mobile device (e.g., 120 of FIG. 2) was present from a location service on mobile device. At operation 720, processor 126 identifies, by querying a database (e.g., 240 of FIG. 2) or a remote service (e.g., 110 of FIG. 2), POIs associated with at least some of the locations. Mobile device 120 may store, in memory 125, a location history based on the identified POIs (operation 730). The location history may comprise data objects identifying the identified POIs. At operation 740, display unit 124 of FIG. 2 displays user interfaces shown in FIGS. 4 and 5 to the user of the mobile device 120. The user interfaces are generated based on location history 160 of FIG. 2 and prompt the user to provide responses to POIs in the location history.

It is to be understood that the disclosure is not to be limited to the disclosed embodiments but, on the contrary, is intended to cover various modifications and equivalent arrangements. Those of skill in the art would appreciate that the various illustrative blocks, modules, elements, components, methods, and algorithms described herein may be implemented as electronic hardware, computer software, or combinations of both. Skilled artisans may implement the described functionality in varying ways for each particular application. Various components and blocks may be arranged differently (e.g., arranged in a different order, or partitioned in a different way) all without departing from the scope of the subject technology.

The specific order or hierarchy of steps in the methods disclosed is an illustration of examples of approaches. The specific order or hierarchy of steps in the methods may be rearranged, e.g., based on design preferences. Some of the steps may be performed simultaneously or in an alternative order. Other embodiments are also within the scope of the following claims.

1. A method comprising:
receiving, at a server, location information for a plurality of locations from a mobile device associated with a user, the locations being locations at which the mobile device was present;
identifying by the server, using the received location information, points-of-interest (POIs) associated with at least some of the locations of the plurality of locations;
generating, by the server, a location history based on the POIs, the location history comprising data objects identifying the POIs; and
transmitting, by the server, to a device authorized by the user, at least a portion of the location history and instructions for causing the authorized device to display a graphical user interface and prompt the user to provide responses to POIs in the location history.

2. The method of claim 1, wherein the received location information comprises at least one of a geographical latitude and longitude, global positioning system (GPS) information, wireless fidelity (Wi-Fi) or other wireless transmitter source information.

3. The method of claim 2, wherein the location history further comprises chronological information indicating when the mobile device was present at each of the POIs, the chronological information being received with the location information for at least some of the locations of the plurality of locations.

4. The method of claim 3, wherein the location history further comprises chronological information indicating a respective duration of time that the mobile device was present at each of the POIs.

5. The method of claim 1, wherein the portion of the location history transmitted, by the server, is limited to POIs at which the mobile device was present for at least a threshold duration of time.

6. The method of claim 1, wherein the portion of the location history transmitted, by the server, is limited to POIs for which the server does not have a response from the user.

7. The method of claim 1, wherein the portion of the location history transmitted, by the server, is limited to POIs for which the server does not have at least a threshold number of responses from users.

8. The method of claim 1, wherein the graphical user interface comprises a map in which POIs are marked or a table including POI identifying information.

9. The method of claim 8, wherein the graphical user interface further allows the user of the mobile device to confirm, for each displayed POI, at least one of:
the user has visited that POI or
the user intends to rate that POI.

10. The method of claim 8, wherein the graphical user interface comprises, for each displayed POI, a graphical element that permits the user to select a graded rating for the respective POI.

11. The method of claim 8, wherein the server receives location information for those locations at which the user has interacted with the mobile device to record the user's presence at the respective location, and wherein the location history is limited to POIs corresponding to such locations.

12. The method of claim 1, wherein displaying the graphical user interface is initiated by at least one of a push or a pull mode, the push mode comprising receiving from the user of a mobile device a request for an interface to provide user responses to POIs in the location history, and the pull mode comprising sending an electronic message to the mobile device to request the user of the mobile device to provide user responses to POIs in the location history.

13. The method of claim 1, wherein the server receives location information from a plurality of mobile devices, each associated with a user, and wherein each location history is stored in a secure format with information associating the location history with the corresponding user.

14. The method of claim 1, wherein each data object identifying the identified POIs comprises a unique identifier referencing the POI in a POI database.

15. The method of claim 1, wherein each data object identifying the identified POIs comprises a descriptive name, a latitude, and a longitude for the respective POI.

16. The method of claim 1, wherein the authorized device to which server transmits at least a portion of the location history and instructions for causing the authorized device to display a graphical user interface is a device other than the mobile device.

17. A method comprising:
receiving, by a mobile device from a location service on the device, location information for a plurality of locations, the locations being locations at which the mobile device was present;
identifying, by the mobile device, POIs associated with at least some of the locations of the plurality of locations by at least querying one or more of a database or a remote service;
storing, by the mobile device, a location history based on the POIs, the location history comprising data objects identifying the POIs; and
displaying, the mobile device, a graphical user interface that prompts the user to provide responses to POIs in the location history.

18. The method of claim 17, wherein the received location information comprises at least one of a geographical latitude and longitude, global positioning system (GPS) information, wireless fidelity (Wi-Fi), or other wireless transmitter source information.

19. The method of claim 17, wherein the location history further comprises chronological information indicating at least one of when the mobile device was present at each of the POIs or a respective duration of time that the mobile device was present at each of the POIs, and wherein the chronological information is received with the location information for at least some of the locations of the plurality of locations.

20. The method of claim 19, wherein the stored location history is limited to POIs at which the mobile device was present for at least a threshold duration of time, and wherein the method further comprises transmitting the responses to the POIs in the location history to a server.

21. The method of claim 20, further comprising generating the location history comprising data objects identifying POIs at which the mobile device was present for at least a threshold duration of time.

22. The method of claim 17, wherein the graphical user interface comprises at least one of a map in which POIs are marked or a table including POI identifying information, and wherein the graphical user interface further comprises, for each displayed POI, a graphical element that permits the user to select a graded rating for the respective POI.

23. The method of claim 17, wherein the graphical user interface further allows the user of the mobile device to confirm, for each displayed POI, at least one of:
the user has visited that POI or
the user intends to rate that POI.

24. The method of claim 17, wherein each data object identifying the identified POIs comprises a unique identifier referencing the POI in a POI database, and wherein each data object identifying the identified POIs comprises at least one of a descriptive name, a latitude, or a longitude for the respective POI.

25. A system comprising:
a communication module configured to receive location information for a plurality of locations from a mobile device associated with a user, the locations being locations at which the mobile device was present;
memory to store a database of location information, wherein the location information is based on the plurality of location information received from one or more mobile devices;
an identification module configured to identify, using the received location information, POIs associated with at least some of the locations of the plurality of locations; and
a location history module configured to generate a location history based on the POIs, the location history comprising data objects identifying the POIs, and
wherein the communication module is further configured to transmit to a device authorized by the user, at least a portion of the location history and instructions for causing the authorized device to display a graphical user interface and prompt the user to provide responses to POIs in the location history.

26. The system of claim 25, further comprising;
a POI database including location information of a number of POIs,
wherein the location history module is further configured to retrieve location information for at least a portion of the number of POIs and generate, based on the location information for the portion of the number of POIs, the location history, wherein the location history includes chronological information indicating when the mobile device was present at the POIs, the chronological information being received with the location information for at least some of the locations of the plurality of locations.

27. The system of claim 25, wherein the location history module is further configured to generate the location history comprising chronological information indicating the duration that the mobile device was present at the POIs.

28. The system of claim 25, wherein the portion of the location history transmitted is limited to at least one of POIs for which the system does not have a response from the user or POIs for which the server does not have at least a threshold number of responses from users.

29. The system of claim 25, further comprising an interface module configured to generate the graphical user interface comprising a map in which POIs are marked or a table including POI identifying information and a graphical element that permits the user to select a graded rating for the respective POI, and wherein the graphical user interface allows the user of the mobile device to confirm, for each displayed POI, at least one of:
the user has visited that POI or
the user intends to rate that POI.

30. The system of claim 25, wherein the communication module is configured to receive location information for those locations at which the user has interacted with the mobile device to record the user's presence at the respective location, and wherein the location history is limited to POIs corresponding to such locations.

31. The system of claim 25, wherein the communication module is configured to receive location information from a plurality of mobile devices, each associated with a user, and wherein the memory is configured to store each location history in a secure format with information associating the location history with the corresponding user.

32. A non-transitory machine-readable medium comprising instructions stored therein, which when executed by a server, cause the server to perform operations comprising:
receiving, at the server, location information for a plurality of locations from a mobile device associated with a user, the locations being locations at which the mobile device was present;
identifying by the server, using the received location information, POIs associated with at least some of the locations of the plurality of locations;
generating, by the server, a location history based on the POIs, the location history comprising data objects identifying the POIs; and
transmitting, by the server, to a device authorized by the user, at least a portion of the location history and instructions for causing the authorized device to display a graphical user interface and prompt the user to provide responses to POIs in the location history.

33. A non-transitory machine-readable medium comprising instructions stored therein, which when executed by a mobile device, cause the mobile device to perform operations comprising:
receiving, by the mobile device from a location service on the device, location information for a plurality of locations, the locations being locations at which the mobile device was present;
identifying, by the mobile device, POIs associated with at least some of the locations of the plurality of locations by at least querying one or more of a database or a remote service;
storing, by the mobile device, a location history based on the POIs, the location history comprising a data objects identifying the POIs; and
displaying a graphical user interface that prompts the user to provide responses to POIs in the location history.

34. A mobile device comprising:
a location manager configured to receive, from a location service on the device, location information for a plurality of locations, the locations being locations at which the mobile device was present;
a processor configured to identify, by querying a database or a remote service, POIs associated with at least some of the locations of the plurality of locations;
memory to store a location history, wherein the location history is determined based on the identified POIs, the location history comprising data objects identifying the identified POIs; and
a display to display a graphical user interface that prompts the user to provide responses to POIs in the location history.

35. The mobile device of claim 34, wherein the received location information comprises at least one of a geographical latitude and longitude, global positioning system (GPS) information, wireless fidelity (Wi-Fi), or other wireless transmitter source information.

36. The mobile device of claim 34, wherein the memory is further configured to store the location history further comprising chronological information indicating at least one of when the mobile device was present at each of the POIs or a respective duration that the mobile device was present at each of the POIs, the chronological information being received with the location information for at least some of the locations of the plurality of locations.

37. The mobile device of claim 36, wherein the memory is further configured to store location history limited to POIs at which the mobile device was present for at least a threshold duration of time.

38. The mobile device of claim 34, further comprising:
a communication module configured to transmit to a server the responses to the POIs in the location history, receive, from the server, one or more location histories comprising data objects identifying POIs at which the mobile device was present for at least a threshold duration, wherein the one or more location histories received from the server is limited to at least one of POIs for which the user of the mobile device has not transmitted any response or POIs for which the user of the mobile device has not transmitted a threshold number of responses.

39. The mobile device of claim 34, wherein the display is further configured to display a graphical user interface comprising at least one of a map in which POIs are marked or a table including POI identifying information, and wherein the graphical user interface further comprises, for each displayed POI, a graphical element that permits the user to select a graded rating for the respective POI.

40. The mobile device of claim 34, wherein the display is further configured to display the graphical user interface that allows the user of the mobile device to confirm, for each displayed POI, at least one of:
the user has visited that POI or
the user intends to rate that POI.

41. The mobile device of claim 34, wherein each data object identifying the identified POIs comprises a unique identifier referencing the POI in a POI database, and wherein each data object identifying the identified POIs comprises at least one of a descriptive name, a latitude, or a longitude for the respective POI.

42. A method comprising:
receiving location information from each of the plurality of mobile devices, the location information from each mobile device comprising a plurality of locations at which the mobile device was present;
identifying, for each of the plurality of mobile devices, points of interest (POIs) associated with at least some of the locations identified in the received location information;
storing, for each of the plurality of mobile devices, a location history comprising a POI list including at least one POI of the one or more POIs;
sending, to at least some of the mobile devices, a respective prompt to elicit a user rating for one or more POIs associated with locations at which the mobile device was present, the POIs being identified by the stored location history; and
providing, to each of the plurality of mobile devices, a respective rating interface determined based on the location history for the corresponding mobile device, the respective rating interface enabling rating of at least one POI of the POI list and being provided at a time subsequent to a time when the device was present at the at least one POI.

43. The method of claim 42, further comprising aggregating ratings received from multiple devices of different users.

44. The method of claim 43, further comprising providing an overall rating of a POI based on the aggregated ratings to a user of a mobile device located near the POI.

45. The method of claim 42, further comprising generating a user interface that shows on a map location information of a number of POIs and allows the user to rank each POI by clicking on a number of stars shown for that POI.
